(19) United States
(12) Patent Application Publication
(10) Pub. No.: US 2013/0175823 A1
(43) Pub. Date: Jul. 11, 2013

(54) MOTOR VEHICLE BODY WITH SEAL

(71) Applicant: GM Global Technology Operations LLC, Detroit, MI (US)

(72) Inventors: Klaus-Albert Priess, Mainz (DE); Michael Alhof, Floersheim (DE)

(73) Assignee: GM GLOBAL TECHNOLOGY OPERATIONS LLC, Detroit, MI (US)

(21) Appl. No.: 13/717,563

(22) Filed: Dec. 17, 2012

(30) Foreign Application Priority Data
Dec. 17, 2011 (DE) 102011121396.5

(51) Int. Cl. B60J 10/08

(52) U.S. Cl. CPC B60J 10/08
USPC 296/146.9

(57) ABSTRACT

A motor vehicle body having body components that are movable against each other between an open and a closed position, is provided. The motor vehicle body includes a first body component with an elongated corner bounded by a first and a second leg, and a seal. The seal includes a basic section fastened to the first leg of the first body component and a main sealing section that is elastically compressed in the closed position in contact with a second one of the body components A first sealing contact zone is formed between the basic section and the first leg, a second sealing contact zone by a rib projecting from the basic section spaced from the first sealing contact zone and bridging a gap between the basic section and the second leg.

### CROSS-REFERENCE TO RELATED APPLICATION

This application claims priority to German Patent Application No. 10 2011 121 396.5, filed Dec. 17, 2011, which is incorporated herein by reference in its entirety.

### TECHNICAL FIELD

The present disclosure relates to a motor vehicle body with two body components that are movable against each other between an open and a closed position such as a door and door frame or tailgate and frame and a sealing profile clamped between the two body components in a closed position.

### BACKGROUND

A sealing profile used for a known sealing of a gap between door 6 and frame 14 of a motor vehicle body is shown in FIG. 1. It comprises a basic section 21 anchored on the door 6 with the help of engagement clips 26, a main sealing section 22 that can be elastically deformed to a high degree in contact with the door frame 14 and a secondary sealing section, which is substantially formed by an elastic rib 40 projecting from the basic section 21 on a side facing the door 6. When the rib 40 shown in FIG. 1 in a relaxed configuration is deflected out of this relaxed configuration in contact with the door 6 and the tip 42 or a flank of the rib 40 presses against the door in a sealing manner, this may lead to a weakening of the contact and an impairment of the sealing effect on a sealing contact zone 41 at the foot of the rib 40. If the tip 42 of the rib 40 does not closely contact the door 6, dirt can accumulate between said rib and the door which over the course of time impairs the sealing effect.

Therefor it may be desirable to create a motor vehicle body with a seal that is improved and less sensitive to dirt accumulation. In addition, other objects, desirable features and characteristics will become apparent from the subsequent summary and detailed description, and the appended claims, taken in conjunction with the accompanying drawings and this background.

### SUMMARY

According to various aspects of the present disclosure, provided is a motor vehicle body having two body components that are movable against each other between an open and a closed position, of which the first body component comprises an elongated corner bounded by a first and a second leg, and a seal, which comprises a basic section fastened to the first leg of the first body component and a main sealing section that is elastically compressed in the closed position in contact with the second body component and forms a first sealing contact zone between the basic section and the first leg of the first body component, comprises a second sealing contact zone which is formed through a rib which projects from the first sealing contact zone spaced from the basic section and bridging a gap between the basic section and the second leg. The local separation between this rib and the first sealing contact zone prevents an impairment of the effect of the first sealing contact zone through a deformation of the rib. For this reason, the rib can exert a strong pressure guaranteeing a secure sealing effect on the second leg without the effect of the first sealing contact zone being impaired because of this. In that the rib blocks the gap between the basic section and the second leg, no dirt can accumulate therein any longer and the tendency for dirt accumulation of the sealing contact zones is reduced.

The rib is substantially elastically deflected in contact with the second leg.

When the basic section is fastened to the first body component through clips engaged in openings of the first leg, at least one of the sealing contact zones, generally both sealing contact zones should be arranged on the weather side of the clips in order to reliably keep away precipitation water from the openings and from the interior of the first body component.

As already mentioned, the first sealing contact zone and the rib should be spaced from each other so that a contact pressure acting between the rib and the second leg does not impair the sealing effect on the first sealing contact zone. If the clips have heads engaging in an undercut groove of the basic section, the rib is therefore generally moved further away from the first flank than the groove.

A further sealing contact zone can extend on a side of the openings facing the vehicle interior between the seal and the first body component.

The further sealing contact zone can be formed in particular on a flexible rib projecting from the basic section. The pressure exerted by such a rib on the first leg if applicable also increases the pressure acting on the first sealing contact zone via lever action.

A covering element of the first body component can be inserted into a gap between the rib and the first leg.

In order to be able to ensure on the one hand a fixed anchorage on the first body component and on the other hand a high deformation of the seal, the basic section and the main section are substantially produced, in particular co-extruded from different elastic materials.

In particular, the first sealing contact zone can be formed by a band whose material is more elastic than that of the basic section in order to greatly deform in contact with the first leg and form a wide sealing surface.

The second rib, too, can be practically formed from a material that is more elastic than that of the basic section, be it in order to facilitate the introducing of the covering element into the gap between the second rib and the first leg or in order to make possible a sealing effect of the second rib even when no covering element is inserted.

Practically, the second rib, if it comprises a material that is more elastic than that of the basic section, can be embodied connected in a materially-joint manner with the likewise highly-elastic main sealing section.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a schematic section through a conventional seal between door and door frame of a motor vehicle body;

FIG. 2 shows a view of a motor vehicle, to which the present disclosure can be applied; and

FIG. 3 shows a section according to the present disclosure analogous to FIG. 1.

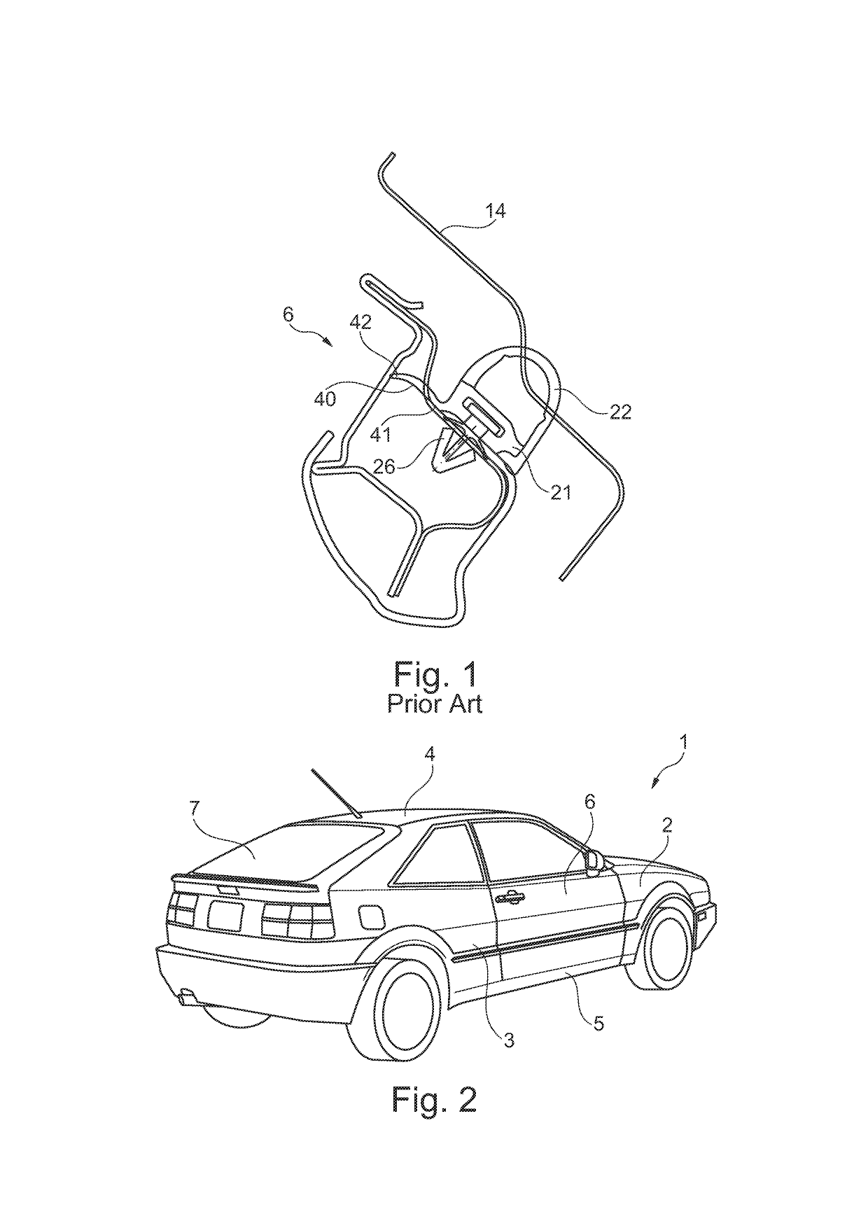

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

In a schematic perspective view, FIG. 2 shows a motor vehicle 1 to which the present disclosure can be applied. The body of the vehicle comprises fixed parts such as for example fenders 2, 3, a roof 4 and a door sill 5, which form a frame about a door 6 that is movable between open and closed position; a tailgate 7 is possible as a further movable body component.

Between the fixed and the movable parts of the body, seals are provided with the intention of keeping precipitation, dirt and draft air away from the interior of the body, in particular from the passenger cell.

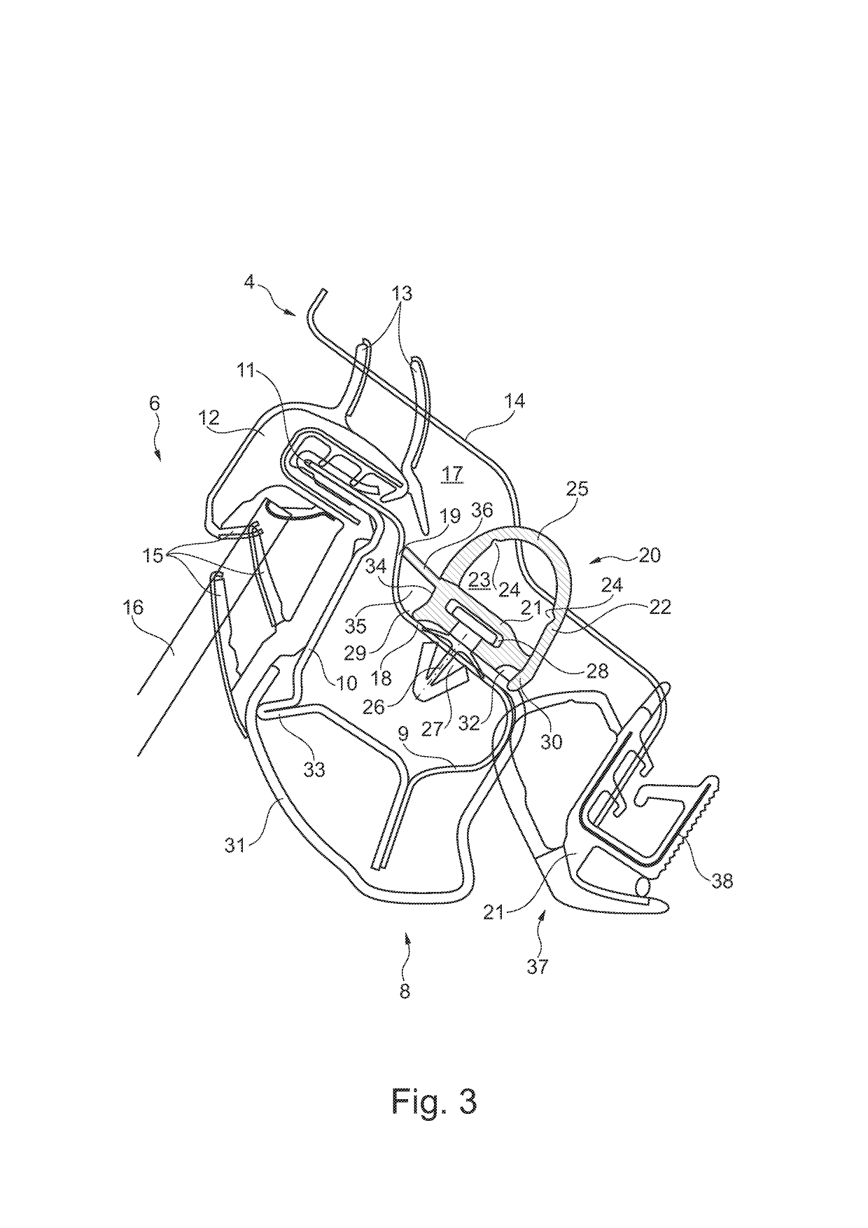

FIG. 3 shows an exemplary seal construction according to the present disclosure by means of a schematic cross section through a marginal region of the roof 4 and an upper region of the door 6 adjoining thereon. A spar 8 bounding a window opening of the door 6 towards the top is joined from two panels 9, 10 welded to each other on their longitudinal margins. The upper longitudinal margins of the panels 9, 10 form a web 11, onto which a plastic profile 12 is fitted on the weather side. Elastic sealing lips 13 of the profile 12 are drawn in the FIG. 3 in their relaxed configuration crossing a side wall panel 14 of the roof 4; in fact, when the door 6 is in its closed position shown in the Figure, said sealing lips are elastically deflected towards the outside in contact with the side wall panel 14. The same applies to sealing lips 15 of the plastic profile 12, which are deflected in contact with a window pane 16 when the latter is in the closed position.

The sealing lips 13 form a first seal of a gap 17 on the weather side, which extends between the panel 9 of the spar 8 and the side wall panel 14 of the roof Two legs 18, 19 of the panel 9 arranged approximately at a right angle to each other, form a corner extending in longitudinal direction of the spar 8, in which a seal 20 is mounted. The seal 20 is an extruded profile from two different materials of varying elasticity. A basic section 21 of the seal 20 facing the leg 18 is entirely or predominantly formed from a relatively stiff material, a main sealing section 22 facing the side wall panel 14 substantially comprises a highly-flexible rubber-elastic material which extends in an arch about a central hollow space 23. Like the sealing lips 13, the main sealing section 22 is shown in a relaxed configuration which it would assume in the open position of the door 6; in the closed position of the door 6, the main sealing section 22 is compressed in contact with the side wall panel 14, wherein two weak locations 24 extending along the main sealing section 22 facilitate the elastic yielding of a section 25 of the main sealing section 22 located between these and the coming into contact with the side wall panel 14.

The seal 20 is anchored on the leg 18 with the help of engagement clips 26 of plastic, which are engaged in two openings 27 distributed along the leg 18 and comprises head positively engaging onto an undercut groove 28 of the basic section 21.

On a lower side of the basic section 21 facing the leg 18, a slightly projecting band 29 extends on the weather side of the openings 27, which is substantially more elastic than the basic section 21 and can be extruded from the same material as the main sealing section 22.

A second rib 30 of elastic material extends on the side of the seal 20 facing the passenger cell. This rib 30, too, is shown in the Figure in a relaxed configuration and, when the door 6 is readily joined, is displaced by the margin of a covering element 31 inserted between the leg 18 and the lower side of the basic section 21 into an adjacent recess 32 of the basic section 21, so that the rib 30 elastically presses against the covering element 31, tightly contacting the latter.

The covering element 31 extends in an arch from under the spar 8 and, in that it engages about a rib 33 of the panel 10 projecting towards the window pane 16, is positively held on the spar 8.

A narrow side 34 of the basic section 21 is located opposite the leg 19 of the spar 8 subject to forming a gap 35. On a margin of this narrow side 34 facing away from the leg 18, a rib 36 projects whose tip elastically presses against the leg 19, thus closing the gap 35 on the weather side.

Here, the rib 36 is formed unitarily with the basic section 21 from the stiffer material, but thanks to its small wall thickness, can still be elastically deflected. Since the ribs 36, 29 are separated from each other through the basic section 21 that is not substantially deformable, a deformation of the rib 36 in contact with the leg 19 does not have an effect on the contact of the rib 29 with the leg 18, so that the rib 36 can contact the leg 19 firmly and in a well-sealing manner without impairing the tightness of the contact between the rib 29 and the leg 18.

A further seal 37 is fitted onto a margin of the side wall panel 14 at an end of the gap 17 facing the passenger cell. This seal 37, too, has a substantially dimensionally stable basic section 21 in this case stiffened through an insert-molded metallic U-profile 38 and a main sealing section projecting into the gap 17 which is easily deformable thanks to an inner hollow space in contact with the covering element 31.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A motor vehicle body with body components movable against each other between an open and a closed position, comprising:
a first body component including an elongated corner bounded by a first leg and a second leg; and
a seal including a basic section fastened to the first leg of the first body component and a main sealing section that is elastically compressed in the closed position in contact with a second body component,
wherein a first sealing contact zone between the basic section and the first leg is formed, and a second sealing contact zone is formed by a rib projecting from the basic section spaced from the first sealing contact zone and bridging a gap between the basic section and the second leg.

2. The motor vehicle body according to claim 1, wherein the rib in contact with the second leg is elastically deflected.

3. The motor vehicle body according to claim 1, wherein the basic section is fastened to the first body component through clips engaged in openings of the first leg and in that at least one of the sealing contact zones is arranged on the weather side of the clips.

4. The motor vehicle body according to claim 3, wherein the clips further comprise heads engaging into an undercut groove of the basic section and in that the rib is further distant from the first flank than the groove.

5. The motor vehicle body according to claim 4, further comprising a further sealing contact zone which extends on a side of the openings facing the vehicle interior between the seal and the first body component.

6. The motor vehicle body according to claim 5, wherein the further sealing contact zone is formed on a flexible second rib that projects from the basic section.

7. The motor vehicle body according to claim 6, wherein a covering element of the first body component is inserted into a gap between the second rib and the first leg.

8. The motor vehicle body according to claim 7, wherein the basic section and the main sealing section are produced from different elastic materials and are co-extruded.

9. The motor vehicle body according to claim 8, wherein the first sealing contact zone is formed by a band, whose material is more elastic than that of the basic section.

10. The motor vehicle body according to claim 9, wherein the second rib is formed of a material that is more elastic than that of the basic section.

11. The motor vehicle body according to claim 10, wherein the second rib is linked to the main sealing section in a materially joined manner.

12. A motor vehicle, comprising:
a motor vehicle body with body components movable against each other between an open and a closed position;
a first body component including an elongated corner bounded by a first leg and a second leg; and
a seal including a basic section fastened to the first leg of the first body component and a main sealing section that is elastically compressed in the closed position in contact with a second body component,
wherein a first sealing contact zone between the basic section and the first leg is formed, a second sealing contact zone is formed by a rib projecting from the basic section spaced from the first sealing contact zone and bridging a gap between the basic section and the second leg, and the rib in contact with the second leg is elastically deflected.

13. The motor vehicle according to claim 12, wherein the basic section is fastened to the first body component through clips engaged in openings of the first leg and in that at least one of the sealing contact zones is arranged on the weather side of the clips.

14. The motor vehicle according to claim 13, wherein the clips further comprise heads engaging into an undercut groove of the basic section and in that the rib is further distant from the first flank than the groove.

15. The motor vehicle according to claim 14, further comprising a further sealing contact zone which extends on a side of the openings facing the vehicle interior between the seal and the first body component.

16. The motor vehicle according to claim 15, wherein the further sealing contact zone is formed on a flexible second rib that projects from the basic section.

17. The motor vehicle according to claim 16, wherein a covering element of the first body component is inserted into a gap between the second rib and the first leg.

18. The motor vehicle according to claim 17, wherein the basic section and the main sealing section are produced from different elastic materials and are co-extruded.

19. The motor vehicle according to claim 18, wherein the first sealing contact zone is formed by a band, whose material is more elastic than that of the basic section.

20. The motor vehicle according to claim 19, wherein the second rib is formed of a material that is more elastic than that of the basic section.
